(19) United States
(12) Patent Application Publication
(10) Pub. No.: US 2012/0099439 A1
(43) Pub. Date: Apr. 26, 2012

(54) Method and Device for Component Carrier Activation and Reconfiguration in a Mobile User Equipment

(76) Inventors: Robert Baldemair, Solna (SE); Ylva Jading, Stockholm (SE); Erik Dahlman, Bromma (SE); David Astely, Bromma (SE)

(21) Appl. No.: 13/381,026

(22) PCT Filed: Jun. 29, 2010
(86) PCT No.: PCT/SE2010/050743

§ 371 Date: Dec. 27, 2011

Related U.S. Application Data
(60) Provisional application No. 61/221,197, filed on Jun. 29, 2009.

(51) Int. Cl. H04W 72/04; H04W 24/00

(52) U.S. Cl. 370/241

(57) ABSTRACT

Methods and user equipment are provided for activation of downlink component carriers. Even though configured to monitor multiple component carriers, a user equipment unit does not start to monitor them immediately, but instead monitors only one or a few carriers initially. Once a downlink scheduling assignment is received, the user equipment unit will then monitor additional component carriers. After one or more subframes where the user equipment unit is not scheduled, the user equipment unit returns to its original state where it monitors one or a few carriers.

### FIELD OF THE INVENTION

The present invention relates to a method and arrangement in a telecommunication system, in particular to methods and arrangements in E-UTRAN for reconfiguration of component carriers monitored by a mobile user equipment.

### BACKGROUND

The long-term evolution of the UTRAN (E-UTRAN), also denoted LTE, has recently been standardized in Release 8 of the 3GPP specifications. This release supports bandwidths up to 20 MHz; however, in order to meet the upcoming IMT-Advanced requirements, 3GPP has initiated continued work on LTE, whereby one aspect concerns supporting bandwidths larger than 20 MHz. One important requirement on these future releases is to assure backward compatibility with LTE Rel-8. This includes inter alia spectrum compatibility which implies that a carrier of an advanced version of the 3GPP-specification which is wider than 20 MHz appears as a number of LTE carriers to an LTE Rel-8 terminal (or user equipment unit). Each such carrier can be referred to as a component carrier. In particular for early deployments of future LTE-releases it can be expected that there will be a smaller number of advanced terminals compared to a large number of LTE legacy terminals. It is therefore necessary to assure an efficient use of a wide carrier also for legacy terminals, i.e. it shall be possible to implement carriers where legacy terminals can be scheduled in all parts of the wideband LTE-Advanced carrier. The straightforward way to obtain this would be by means of carrier aggregation. Carrier aggregation implies that a terminal that is compliant to an advanced version of the 3GPP-specification can receive multiple component carriers, where the component carriers have, or at least have the possibility to have, the same structure as a Rel-8 carrier. Carrier aggregation is shown in FIG. 1 illustrating 5 carriers with 20 MHz bandwidth forming an aggregated bandwidth of 100 MHz.

The number of aggregated component carriers as well as the bandwidth of the individual component carrier may be different for Uplink (UL) and Downlink (DL). A symmetric configuration refers to the case where the number of component carriers in DL and UL is the same whereas an asymmetric configuration refers to the case that the number of component carriers is different. It is important to note that the number of component carriers configured in a cell may be different from the number of component carriers seen by a terminal: A terminal may for example support more DL component carriers than UL component carriers, even though the cell is configured with the same number of UL and DL component carriers.

A majority of the power consumption in a terminal is consumed by its analog front-end. Forcing a terminal to always monitor multiple DL component carriers is therefore not very energy efficient.

One possible solution to avoid this disadvantage is to semi-statically configure the DL component carriers that the terminal should monitor. Monitoring here typically means reading the physical Downlink Control Channel (PDCCH) and if a DL assignment is found also reading Physical Downlink Shared Channel (PDSCH). Semi-static configurations are typically performed via RRC signaling. It is a disadvantage of this solution that a long delay is introduced: As reconfiguring the component carriers to be monitored by the terminal can take several hundred milliseconds, a terminal could only start to receive on multiple component carriers after said several hundred milliseconds. Also the reconfiguration from multiple to one (or few) component carriers requires the same time resulting in low energy efficiency. On the other hand, an advantage of semi-statically configurations is a high degree of reliability.

Another solution to avoid the above mentioned disadvantage is the usage of L1/L2 control signaling. However, whereas L1/L2 control signaling is fast, it is not very reliable; it is not even protected by HARQ retransmissions.

### SUMMARY

It has thus been identified to be a problem that prior art solutions, RRC signaling or L1/l2 control signaling as described above, for reconfiguring the component carriers monitored by a terminal are either reliable but too slow (RRC signaling) or fast but unreliable (L1/L2 control signaling).

It is therefore an object of the embodiments of the present invention to achieve a method and arrangement for reconfiguration of component carriers that alleviates at least some of the drawbacks identified in prior art solutions.

Basically, the embodiments of the present invention relate to a method in a user equipment unit and an arrangement in a user equipment unit for which, via RRC signaling, the component carriers to be monitored are configured. Even though configured to monitor multiple component carriers, the user equipment unit does not start to monitor them immediately but only one, or very few, carriers. Only if it decodes a DL assignment it will start to monitor multiple component carriers. After one, or possibly multiple, subframes where the user equipment unit has not been scheduled anymore it falls back to its original state, i.e. it only monitors one (or very few) component carriers.

The embodiments of the present invention imply the advantage that they enable a radio reconfiguration in the terminal with reasonable reliability and delay. Further, it is possible to create a guard times for a terminal that might be needed to reconfigure their radio.

Other objects, advantages and novel features of the invention will become apparent from the following detailed description and claims when considered in conjunction with the accompanying drawings.

### BRIEF DESCRIPTION OF THE DRAWINGS

FIG. 1 illustrates an example of carrier aggregation.

FIG. 2 illustrates a first embodiment of the present invention.

FIG. 3 illustrates a second embodiment of the present invention.

FIG. 4 illustrates a third embodiment of the present invention.

FIGS. 5a-5c illustrate embodiments of the method according to the present invention as performed by a user equipment.

FIG. 6 illustrates embodiments of a user equipment unit according to the present invention.

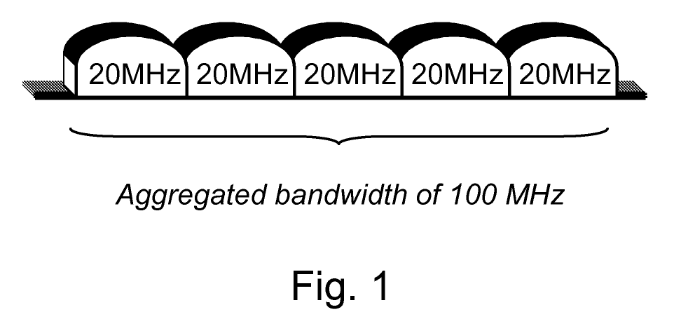

### DETAILED DESCRIPTION

A UE is semi-statically configured to receive a certain set of component carriers. This set is denoted the “DL component carrier set”. However, in its initial state the terminal still monitors only one or very few component carriers. These carrier(s) can be denoted as anchor carrier(s). Exactly which carrier(s) these are can be semi-statically configured or broadcasted via system information. Anchor carrier(s) could also be denoted, e.g., “Reduced DL component carrier set” or “Default DL component carrier set”. Once a terminal has received a DL assignment via PDCCH on its anchor carrier(s) it starts monitoring all carriers within the DL component carrier set.

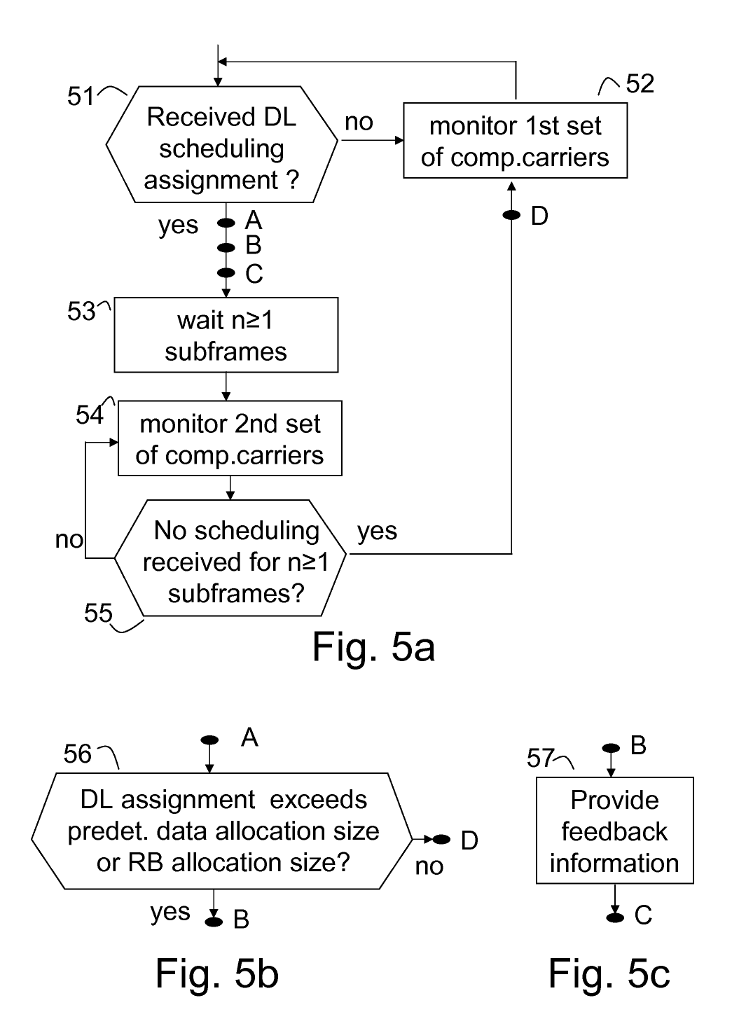

FIGS. 5a-5c illustrate embodiments of the method according to the present invention as performed by a user equipment. The user equipment monitors 52 a first set of component carriers consisting of very few component carriers as described above. When receiving 51Yes a downlink scheduling assignment via a downlink control channel on one of the component carriers of said first set the user equipment starts monitoring 54 the carriers within a second set of component carriers and returns to a monitoring state of only said first set of component carriers after that the user equipment has not been scheduled for one or more subframes 55yes. Said monitoring of said second set is started 53 after one, or optionally a number n (n>1), of subframes after having received said assignment, whereby said number n has either a fixed standardized quantity or has been interchanged between user equipment and base station during a capability exchange.

According to a first option, as depicted in FIG. 5b, the activation of said second set is only performed if said downlink assignment exceeds at least one of a predetermined data allocation size or radio bearer allocation size (56yes).

According to a further option, as depicted in FIG. 5c, a feedback message is transmitted 57 on receipt of the downlink scheduling assignment.

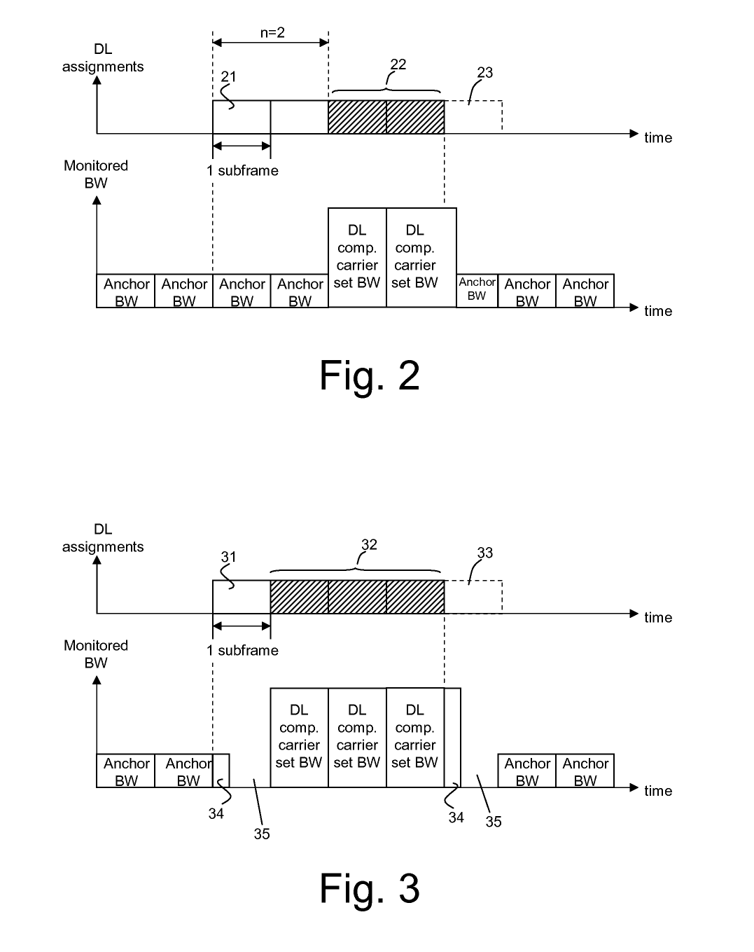

One embodiment is that the terminal receives in the current subframe on the resource blocks assigned to it and starts monitoring the DL component carrier set n subframes later (n≧1). The size of n depends on the time that is needed to reconfigure the terminal and on the reliability eNodeB assumes for this reconfiguration. This can be either a fixed standardized number or can be interchanged between terminal and eNodeB during capability exchange. FIG. 2 illustrates an example where the terminal requires two subframes to reconfigure its radio. In the example of FIG. 2, reception of the original bandwidth is not interrupted until the radio is reconfigured to the new bandwidth. The first DL assignment 21 is therefore a non-zero RB (resource block) assignment. After reading the control region of the subframe and decoding the DL assignment the terminal starts to reconfigure its radio. During radio reconfiguration the terminal is scheduled on the anchor carrier(s). The terminal requires two subframes (n=2) to reconfigure its reception bandwidth. During the subsequent period 22, assignments can be for all component carriers within the downlink component carrier set. The last DL assignment 23 can either be omitted or a zero RB assignment is sent to reconfigure the terminal back to receive only on the anchor carrier(s). In this example is assumed that the eNodeB trusts the terminal to receive the first DL assignment correctly and therefore continues to schedule the terminal after said first DL assignment. After two subframes the eNodeB start scheduling on component carries within DL component carrier set.

Another embodiment is that activation of the DL component carrier set is only triggered if the DL assignment exceeds a certain data or RB allocation size. This is useful since the eNodeB probably assigns a terminal for which the eNodeB has much data in its DL buffer—and would require multiple component carriers (when once activated)—which probably is a rather large portion of the resources available on the anchor carrier(s). As said before, this threshold can be data or transport block size as well as number of allocated RB. The exact size of threshold would be configured.

Yet another embodiment is that a terminal is scheduled in the DL but the assignment is actually zero RB to create a guard time. During radio reconfiguration—to receive the DL component carrier set—a terminal may be unable to receive any component carrier, not even the anchor carrier(s), for a certain time. Typically this time is less than one subframe. The guard time created by the zero RB DL assignment can be used by the terminal to reconfigure the radio. After the terminal receives a zero RB DL assignment it starts monitoring the DL component carrier set n subframes later (n≧1). Note that a scheduling assignment of zero size can be called differently than “scheduling assignment”. An example is illustrated in FIG. 3. In this example the terminal cannot receive on any DL component carrier during radio reconfiguration 35. The first DL assignment 31 is therefore a zero RB assignment. After reading the control region of the subframe and decoding the DL assignment the terminals starts to reconfigure its radio. During the subsequent period 32, assignments ca be for all component carriers within the downlink component carrier set. The last DL assignment 33 can either be omitted or another zero RB assignment is sent to reconfigure the terminal back to receive only on the anchor carrier(s). Here, the control region 34 spans only the beginning of the subframe. In this example it is assumed that the eNodeB trusts the terminal to receive DL assignment correctly and therefore schedules the terminal after the first DL assignment on component carries within DL component carrier set.

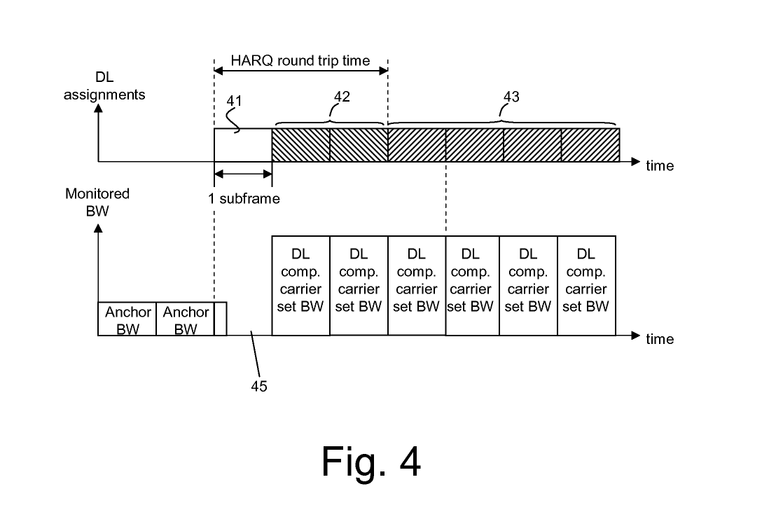

After the eNodeB has scheduled a terminal in the DL it does actually not know whether the terminal could successfully decode the DL assignment and thus started to monitor DL component carrier set. It may anyway, if this reliability is high enough for an eNodeB implementation, start immediately to schedule the terminal on carriers within DL component carrier set. If the eNodeB requires more reliability it does not schedule the terminal in the next subframe(s) but waits until it receives HARQ ACK/NACK feedback on the DL assignment. Even if the assigned resources were zero RB, an ACK/NACK feedback needs to be created. In this special case, however, the ACK/NACK does not indicate the integrity of the (zero size) payload but only that the DL assignment control message was decoded correctly. Once the eNodeB receives ACK/NACK feedback it knows that the terminal received the DL assignment and reconfigured the radio to monitor the DL component carrier set. Thus, it is not important whether the received feedback is ACK or NACK, it is only important that a feedback is received. As in LTE FDD the HARQ round trip time is 8 ms, the eNodeB knows 8 ms later whether the terminal has received the DL assignment and reconfigured its radio. From this time the eNodeB schedules the terminal on carriers within DL component carrier set. TCP slow start an initial delay of 8 ms does not pose a problem. Until the time the feedback is received (but after the time during which the UE cannot receive any component carrier due to radio configuration) the terminal can still be scheduled on the anchor carrier(s). An example is provided in FIG. 4. In this example the terminal cannot receive on any DL component carrier during radio reconfiguration 45. The first DL assignment is therefore a zero RB assignment. After reading the control region of the subframe and decoding the DL assignment the terminals starts to reconfigure its radio. Even though the terminal successfully receives the DL assignment and reconfigures its radio the eNodeB does not rely on this and schedules only the anchor carrier(s). Assignments within the HARQ round trip time can be for all anchor carriers whereas the eNodeB after having received the HARQ feedback (not shown in the picture) starts to schedule on component carriers 43 within the DL component carrier set.

In a further embodiment, if the improved reliability is still not sufficient, the eNodeB configures the anchor carrier(s) of the terminal to be the same set as the DL component carrier set. In this case the UE always observes the complete configured set. Since this configuration is done semi-statically—typically with reliable RRC signaling—the highest reliability is achieved. As stated before, the price that needs to be paid is long delays and high power consumption of the terminal.

Deactivation of the DL component carrier set: After a terminal has not been scheduled on any DL component carrier within the DL component carrier set for n subframes (n≧1), it is one conceivable embodiment of the present invention that the terminal reconfigures the radio and starts to monitor only the anchor carrier(s). Another embodiment is to use again a zero RB DL assignment. In this case the zero RB assignment toggles the radio from DL component carrier set reception to anchor carrier(s) reception. The eNodeB can check that the terminal received zero RB assignment and reconfigured radio by checking HARQ ACK/NACK feedback. If said feedback has been received, the terminal received the zero RB assignment and reconfigured the radio; otherwise eNodeB can send the zero RB assignment again. Yet another embodiment, instead of using a zero RB assignment, is to configure the terminal to reconfigure its radio to anchor carrier(s) reception after reception of a DL assignment smaller than a threshold.

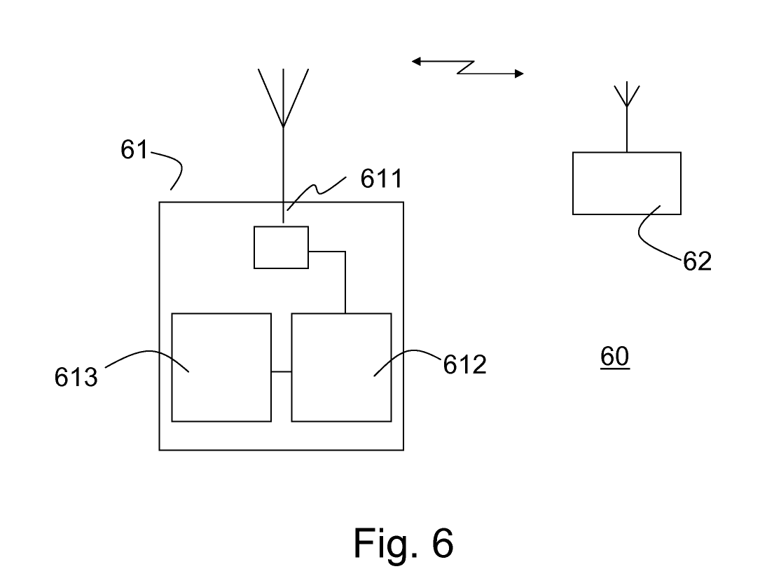

FIG. 6 illustrates embodiments of a user equipment unit 61 according to the present invention. The user equipment unit is located in a cell of a cellular radio communication system 60 and comprises receiver and transmitter elements 611 to communicate with a radio base station (62) in said cell. Further, the user equipment unit includes a first processor 612 operable to monitor a first or second set of component carriers for downlink scheduling assignments received from radio base station via a downlink control channel on one of the component carriers; and includes a second processor 613 connected to said first processor 611 and operable to initiate said first processor 612 to monitor the second set of component carriers in response to a received downlink scheduling assignment on one of the component carriers of a first set of component carriers and to monitor the first set of component carriers in response to not having received a downlink scheduling assignment for one or more subframes.

Even though outlined here in the context of DL assignments parts of the invention may also be applicable to the UL. The eNodeB may receive information from a terminal, for example via UE buffer status report, that it has much data to transmit. If UL grants are transmitted to such a terminal on carriers within DL component carrier set (depends on PDCCH design) UE needs to monitor DL component carrier set. This can be done with zero or none-zero DL assignments as described above. Additionally, the terminal needs to configure UL transmitters. However, UL grant is valid for the UL subframe 4 ms later; this is enough time to reconfigure the UL transmitter if needed.

1. A method in a mobile user equipment unit in a cell of a cellular radio communication system for activation of downlink component carriers, comprising:
monitoring a first set of component carriers;
receiving a downlink scheduling assignment via a downlink control channel on one of the component carriers of the first set;
monitoring the carriers within a second set of component carriers; and
monitoring only the first set of component carriers after that the user equipment has not been scheduled for at least one subframe.

2. The method of claim 1, wherein the monitoring of the second set is started a number n, n≧1, of subframes after having received the assignment.

3. The method of claim 2, wherein the number n has a fixed standardized quantity.

4. The method of claim 2, wherein the number n has been interchanged between user equipment and base station during a capability exchange.

5. The method of claim 1, wherein the activation of said second set is only performed if the downlink assignment exceeds at least one of a predetermined data allocation size and radio bearer allocation size.

6. The method of claim 2, wherein the downlink scheduling assignment assigns no radio bearer for creating a guard time, the user equipment unit performing a radio reconfiguration.

7. The method of claim 1, further comprising:
transmitting a feedback message on receipt of the downlink scheduling assignment.

8. The method of claim 1, wherein the first set of component carriers comprises a predefined default set of downlink component carriers and wherein the second set of component carriers comprises all carriers within a downlink component carrier set.

9. A user equipment unit in a cell of a cellular radio communication system, the user equipment unit comprising receiver and transmitter elements to communicate with a radio base station in the cell, comprising:
a first processor operable to monitor a first or second set of component carriers for downlink scheduling assignments received via a downlink control channel on one of the component carriers; and
a second processor connected to the first processor and operable to initiate the first processor to monitor the second set of component carriers in response to a received downlink scheduling assignment on one of the component carriers of the first set of component carriers and to monitor the first set of component carriers in response to not having received a downlink scheduling assignment for at least one subframe.

10. The method of claim 9, wherein the first set of component carriers comprises a predefined default set of downlink component carriers and wherein the second set of component carriers comprises all carriers within a downlink component carrier set.
